(19) United States
(12) Patent Application Publication
(10) Pub. No.: US 2011/0029318 A1
(43) Pub. Date: Feb. 3, 2011

(54) GLOBAL OPERATOR LICENSE PRIORITIZING AND DISTRIBUTION

(76) Inventors: Anna Pucar Rimhagen, Motala (SE); Stefan Engström, Linkoping (SE)

Correspondence Address: MYERS BIGEL SIBLEY & SAJOVEC, PO BOX 37428, RALEIGH, NC, 27627, US

(21) Appl. No.: 12/936,663

(22) PCT Filed: Jun. 16, 2008
(86) PCT No.: PCT/SE2008/050718

§ 371 Date: Oct. 6, 2010

(51) Int. Cl. H04W 16/00; H04W 28/00

(52) U.S. Cl. 705/1.1

(57) ABSTRACT

A global licensing method and a licensing server are described in which licenses for public land mobile network (PLMNs) are allowed to cross PLMN boundaries. The licenses are moved from PLMNs of lower priority to PLMNs of higher priority. In one example, the licenses are moved on a periodic basis. In another example, the licenses are moved on an as needed basis. When demands for licenses are greater than the supply, the PLMNs are prioritized and the licenses are moved from the lower priority PLMNs to higher priority PLMNs. A global license server can be utilized to manage the licenses for the global operator.

### TECHNICAL FIELD

The disclosed technology generally relates to method(s) and apparatus(es) for managing global operator licenses, for example, in a mobile telephony network.

### BACKGROUND

In FIG. 1, a simplified architecture of a LTE (Long Term Evolution)—a type of a mobile telephony network—is illustrated. The network structure is similar for other mobile telephony networks such as GSM or WCDMA. The mobile telephony networks can also be referred to as public land mobile networks (PLMNs). Among many parts, the PLMN includes of a radio network (RN) part and a core network (CN) part. Radio base stations (eNBs in FIG. 1) reside in the radio network part. In the core network part, there are mobility control servers and the payload routers (and other equipment that is not included in the picture). In general, both the radio and the core network parts have licenses that determine what the operator of the PLMN has bought and thus is allowed to use regarding capacities and features. The licenses are often separated for the radio and the core networks, as well as within the entities of the radio and core networks, but the licenses can also be combined.

The licenses for the network are typically controlled by a license server. At a certain level of licensing such as network licensing, it is possible to move the licenses between elements within the network. There are different levels of licensing. The levels range from node level licensing (where a license is bought for a specific network element (for example a radio base station (RBS)) upto on-demand licensing, where the network elements use the capacity they need, which is registered and then the operator is charged afterwards. The on-demand licensing is analogous to being charged for utility such as water and electricity usage in a household.

### SUMMARY

A global or nation wide operator may operate multiple PLMNs around the world or within a country. For such an operator, the conventional network-based licensing scheme is inadequate. In the conventional network-based licensing scheme, each license is tied to the particular PLMN. Because the licenses are bound to the network, this requires a separate license server for each network. But even a bigger disadvantage is that each PLMN must be individually configured for peak demand. For a global operator, this requires the operator to purchase and maintain more licenses that the operator needs at any given time.

To address this and other issues, global licensing method(s) and apparatus(es) is(are) described in which the licenses are allowed to cross PLMN boundaries. In this manner, the licenses can be moved from PLMNs in which there is relatively less demand to PLMNs in which there is relatively more demand. In one aspect, the licenses are distributed or moved on a periodic basis. As an example, the licenses can be moved from PLMNs operating during sleeping hours to PLMNs operating during day time hours. As another example, the licenses can be moved from PLMNs operating during off season to PLMNs operating during peak season. In another aspect, the licenses are distributed dynamically on an as needed basis.

Regardless of how inactive a particular PLMN may be, it is preferred that some minimum licensed capacity be available for the PLMN so that services can be provided by the PLMN.

When there are not enough licenses available to meet the need for licensed capacity demands, the licenses can be moved from lower priority PLMNs to higher priority PLMNs. The movement can be soft (no interruption in service currently being provided) or hard (interruption of service).

Instead of multiple network-based license servers, a global license server can be provided to manage the licenses for the plural PLMNs operated by the global operator. It is preferred that the vendor (the license provider) has visibility into the license server to manage the licenses and to prevent misuse.

### DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 illustrates a simplified architecture of a mobile telephony network;

FIG. 2 illustrates an operator operating plural mobile telephony networks;

FIG. 3 illustrates a situation in which licenses are tied to individual networks and a license server is provided for each network for license management;

FIG. 4 illustrates a non-limiting embodiment in which licenses are allowed to cross the network boundaries;

FIG. 5 illustrates an example method to manage licenses for plural public land mobile networks of a global operator;

FIG. 6 illustrates an example method to prioritize the licenses distribution for the plural networks;

FIG. 7 illustrates another example method to prioritize the licenses distribution for the plural networks;

FIG. 8 illustrates an example method to distribute the licenses to the plural networks;

FIG. 9 illustrates an example method to move licenses from lower priority networks to higher priority networks; and

FIG. 10 illustrates an embodiment of a global license server.

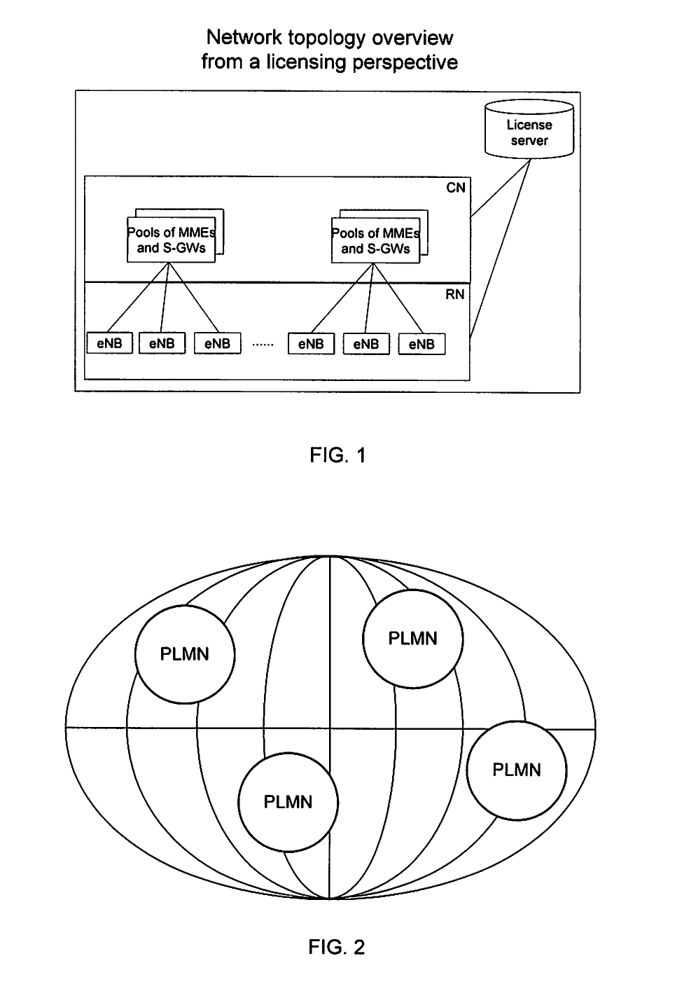

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope.

In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

As noted above, the licenses for each mobile telephony network such as a PLMN are typically controlled by a license server. At a certain level of licensing such as a network level licensing, it is possible to move the licenses between elements of the network to satisfy specific capacity needs that may arise from time to time. Regardless of the level of licensing however, the licenses are connected to a specific PLMN (public land mobile network).

But a global operator may operate more than one network as illustrated in FIG. 2. For example, an operator may operate plural PLMNs globally cross many countries and across multiple continents such as US, Sweden and Japan. Even within one country, an operator may operate multiple PLMNs, for example, New York, Washington, D.C., Chicago and Los Angeles. Because the licenses are connected to a specific PLMN, a global operator, with more than one network, will have separate license servers and solutions for each of their PLMNs.

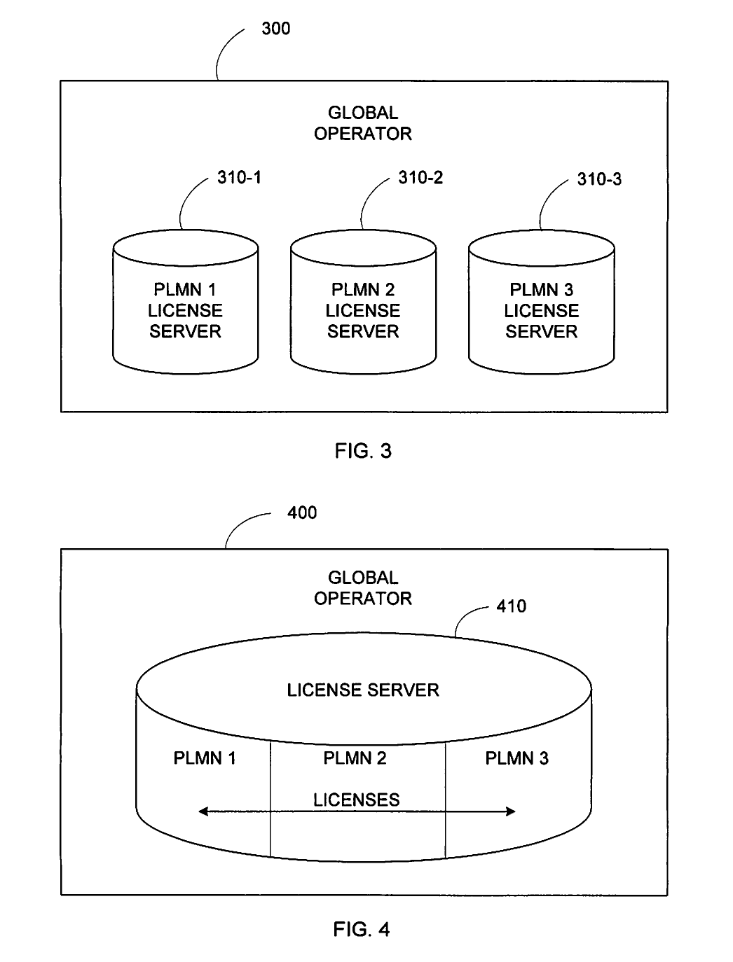

From a perspective of the global operator, this causes problems in that excess licenses must be purchased to meet the expected capacity demands since each PLMN must be individually configured to handle the expected peak demand. This is explained with reference to FIG. 3 which illustrates a global operator operating three different networks PLMN-1, PLMN-2 and PLMN-3. The licenses for the PLMNs are managed by respective license servers 310-1, 310-2 and 310-3. In FIG. 3, it is assumed that the PLMNs operate in geographically dispersed regions such as the US (for PLMN-1), Sweden (for PLMN-2) and Japan (for PLMN-3). It is also assumed that to meet the peak demand capacity (such as during day time hours), each PLMN requires ten (10) licenses. But during the sleeping hours, two (2) licenses are sufficient and during the evening hours, five (5) licenses are sufficient for each PLMN to meet the capacity demand. Since each PLMN must have the capacity to meet the respective peak demand, a total of thirty (30) licenses are required for the three networks.

However, the aggregate peak demand at any given time for the three networks is expected to be less than thirty. For example, if it is daytime in the US, it is evening in Europe and sleeping hours in Asia. Then a total of seventeen (17) licenses—10 for US, 5 for Sweden and 2 for Japan—would be enough to meet the demand. Providing for a small amount of excess capacity, a total of twenty (20) licenses may be sufficient to meet the aggregate total demand at any given time and also provide some safety margin. But since the licenses are tied to individual PLMNs, they cannot be reused in a PLMN in another part of the world. As a result, the operator must purchase excess licenses.

To address this problem, in one non-limiting embodiment, the licenses are allowed to cross the PLMN boundaries as illustrated in FIG. 4. In this figure, there is a global license server 410 managing the licenses for the PLMN-1 (US), PLMN-2 (Sweden) and PLMN-3 (Japan). The licenses are distributed by the global license server 410 to meet the capacity demand for the three networks in an optimal fashion so that the number of licenses needed are kept to a minimum. From the operator's perspective, this has the advantage of minimizing the number of licenses needed (which reduces costs and maintenance) while maintaining sufficient capacity to meet customer's demands, which will enhance the customer's satisfaction. From the vendor perspective—ones who provide the licenses to the operator to operate network elements—there is an advantage in that revenue per license can be increased.

The global operator may also operate multiple PLMNs within a country as well. For example, the networks PLMN-1, PLMN-2 and PLMN-3 may serve Washington, D.C, Chicago, Ill. and Los Angeles, Calif., respectively. The number of PLMNs operated by a global operator is not limited to three and can be any number.

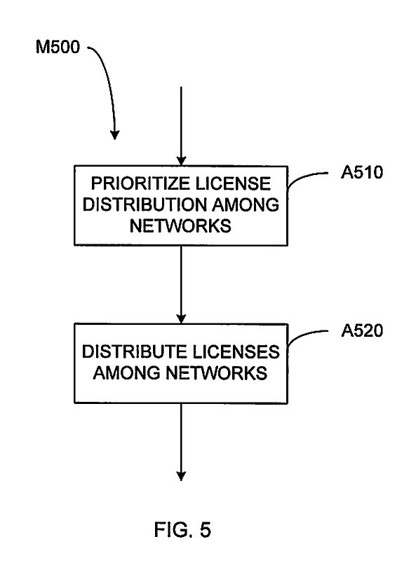

FIG. 5 illustrates an example method M500 to manage licenses for plural public land mobile networks (PLMNs) of a global operator. The method M500 includes A510 of prioritizing a distribution of licenses among the plural PLMNs and A520 of distributing the licenses across the plural PLMNs based on the distribution determined in A510. The method M500 may be performed by a single global license server for the global operator.

In A510, the licenses of the PLMNs are prioritized such that in A520, the licenses are moved from PLMNs operating during peak hours to PLMNs operating during low traffic hours. In one embodiment, the licenses can be prioritized for distribution on a periodic basis. Referring back to FIG. 4, if the PLMNs are globally distributed, then the PLMN-1 may experience its greatest demand for services during GMT hours 0:00-7:59 since that is when its subscribers are the most active (such as during day time). Similarly, the PLMN-2 and PLMN-3 may experience most demand during GMT hours 8:00-15:59 and 16:00-23:59, respectively, when they are at their day time hours.

Each PLMN would have licensing distribution priority coinciding with the peak demands. For example, during the GMT hours 0:00-7:59, more licenses would be available to the PLMN-1 than to either the PLMN-2 or the PLMN-3. Note that the duration of priority of the PLMNs need not be equally distributed as in the example and can be tailored to fit the particular circumstances of the operator.

Another example of prioritizing the licenses on a periodic basis include prioritizing based on days of the week. As a way of explanation, a PLMN may be located in a region where recreational activities predominate (golf courses, restaurants, sports stadiums, and the like). The PLMNs serving these areas would tend to be more busy during the weekend rather than during the weekdays.

Yet another example of prioritizing the licenses on a periodic basis include prioritizing based on seasons of the year. If a PLMN is located near a ski resort in the US, then the PLMN should have priority during the ski season such as between December and May. If a PLMN serves a beach resort in Europe, then it should have priority during the months between June and September. If a PLMN serves coastal areas of Australia, then the PLMN should have licensing priority during the months of October to December.

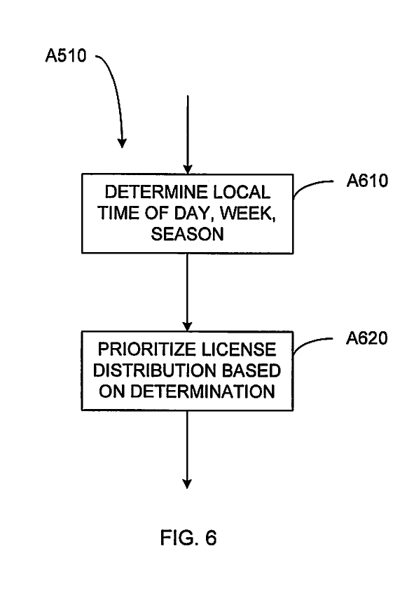

FIG. 6 illustrates an example method to perform A510 of prioritizing the PLMN licenses distribution. In A610, for each PLMN, characteristics of the PLMN such as local time of day, day of the week, season of the year, etc. are determined. In A620, the license distribution is prioritized based on the determination in A610.

The priority may be set on any combination of the factors. The priority may be set for a PLMN taking into account the time of day, season of the year, location and the like. In general, PLMNs operating in peak hours would be prioritized over PLMNs operating in low traffic hours. As an example, for PLMNs operating in business district locations, one would expect that PLMNs operating in day time hours would be prioritized over PLMNs operating over PLMNs operating in night time hours and PLMNs operating in weekday hours would be prioritized over PLMNs operating in weekend hours. Of course, if the PLMN is located in an area with primarily recreational activities, then the PLMN may actually experience more heavy demand during the evening and weekend hours. Further, it would be expected that PLMNs operating in locations with in-season service demands would be prioritized over PLMNs operating in locations with off-season service demands.

Regardless of how inactive a PLMN may be (for example, operation during sleeping hours), it is expected that some capacity will be needed at all times. A PLMN should not be rendered inoperative due to lack of licensed capacity. Thus, for each PLMN, at least a predetermined minimum licensed capacity is preferred to be allocated at all times. The predetermined minimum licensed capacity can be individually set for each PLMN. For example, if the PLMN-1 operates in a location with many subscribers (e.g., a major metropolitan city) and the PLMN-2 operates in a location that has relatively few subscribers (e.g., country side), then the predetermined minimum licensed capacity for the PLMN-1 is expected to be greater than the predetermined minimum licensed capacity for the PLMN-2.

The predetermined minimum licensed capacity need not remain fixed, and is preferred to be individually configurable for each PLMN. As the circumstances change (e.g., the city is growing in population), it is preferred that the operator be free to set the predetermined minimum licensed capacity to accommodate the particular circumstance.

In another embodiment, the licenses can be distributed dynamically depending on the need and priority. That is, the licenses can be prioritized dynamically based on the mobile telephony service demands on the plural PLMNs. In this embodiment, the network elements would inform the license server (either directly, or via a more central network element, or via a management system) of its license needs, and receive the licenses in return from the license server (either directly, or via a more central network element, or via a management system). As long as there are more licenses available than are being used, the process is simple—the request for license can be fulfilled.

However, when the license requests exceeds the availability, then the PLMNs themselves can be prioritized to determine the license distribution priority and the licenses may be distributed accordingly. The PLMN priorities can be set a many different levels such as the PLMN, region (e.g. cell clusters), RBS, cells and/or user groups. Each entity can be given a priority level. There can be several priority levels to choose from, and thus, the PLMN can be prioritized higher or lower than others depending on the circumstances.

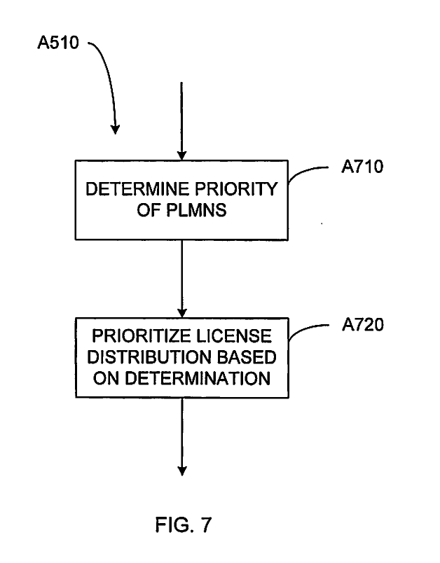

FIG. 7 illustrates an example method to perform A510 of prioritizing the PLMN licenses distribution dynamically. In A710, the license priority of each PLMN is determined. A first PLMN may be prioritized over a second PLMN in multiple ways. For example, the first PLMN would be prioritized when an amount of licensed activity of the first PLMN is greater than an amount of licensed activity the second PLMN. As another example, when a rate of increase in the licensed activity of the first PLMN is greater than a rate of increase in the licensed activity of the second PLMN, the first PLMN would be prioritized. As a further example, the first PLMN would be prioritized when a spare amount of licensed capacity of the first PLMN is less than a spare amount of licensed capacity the second PLMN. As yet further example, when a revenue gain from the first PLMN from the license is greater than a revenue gain from the second PLMN from the license, the first PLMN would be prioritized.

Within each PLMN, the priorities can be determined for each of one or more clusters of cells of the PLMN, each of one or more cells of the PLMN, and/or each of one or more user groups of the PLMN. That is, more than one priority could be set per entity of the PLMN.

In A720, the license distribution among the plural PLMNs is prioritized based on the determination in A710. Note that within each PLMN, the licenses can also be distributed based on the priorities determined for each of one or more clusters of cells of the PLMN, each of one or more cells of the PLMN, and/or each of one or more user groups of the PLMN.

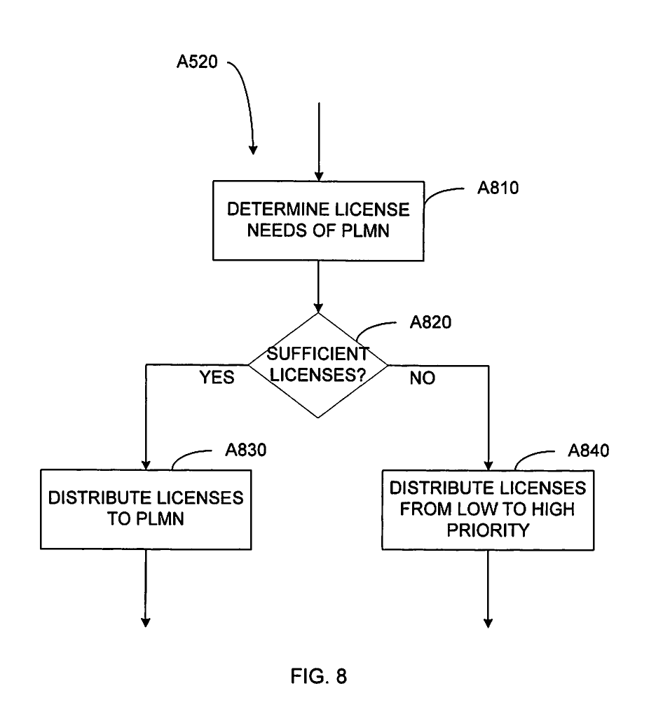

Referring back to FIG. 5, after the distribution of licenses among the plural PLMNs are prioritized in A510, the licenses are distributed in A520. FIG. 8 illustrates an example method to perform A520. In A810, the license needs—that is, the demand—for each PLMN is determined. In A820, it is determined whether there are sufficient licenses available to meet the license needs. If there are sufficient licenses, then the licenses to each PLMN are distributed in A830.

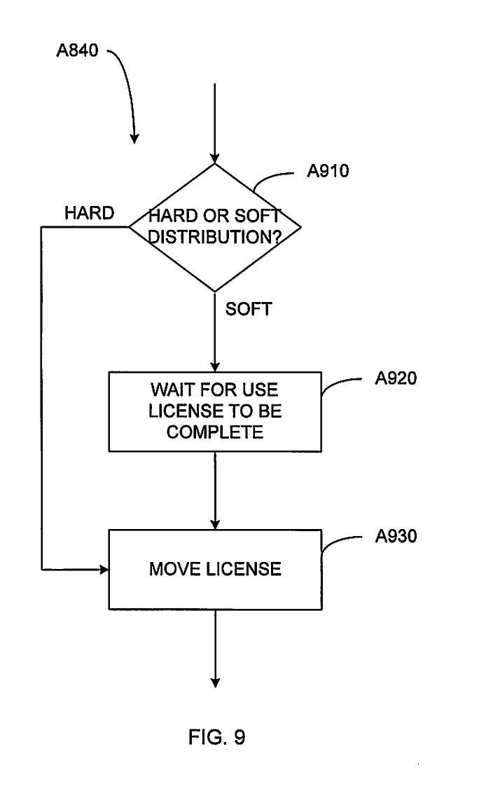

However, if there are not enough licenses to meet the needs, then the licenses from lower priority PLMNs are moved to higher priority PLMNs in A840. The license can be moved in a soft or hard way. FIG. 9, which illustrates an example method to perform A840, is provided as a way of explanation. In A910, it is determined whether the license distribution is hard or soft. If the license distribution is determined to be soft, then the method waits until the use of the license is complete by the lower priority PLMN in A920 and the license is moved to the higher priority PLMN in A940 afterwards. If the license distribution is determined to be hard, then the license is moved from the lower priority PLMN to the higher priority PLMN without waiting. With the soft distribution, a service currently being fulfilled in the lower PLMN is not interrupted, e.g., at the user level, a call in progress is not interrupted. In contrast, the current service can get interrupted when the distribution is hard.

It is preferred that hysteresis information be maintained to avoid the “ping pong” effect. This is a phenomena where a movement of a license from a first PLMN to a second PLMN causes a movement of the same license back to the first PLMN. One way to prevent the ping pong effect is as follows. When a license is moved from the first to the second PLMN, the license can be prevented from being moved back to the first PLMN before a predetermined amount of time expires. Another way is to prevent the license from being moved back before the licensed capacity is used by the second PLMN a predetermined number of times. Yet another way is to prevent the license from being moved back until a predetermined amount of revenue is generated by the second PLMN using the licensed capacity. Any combination of these and others may be used to prevent the ping pong effect.

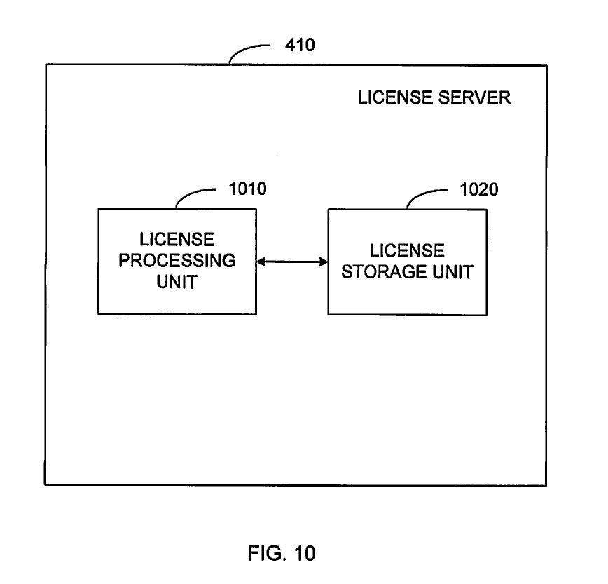

FIG. 10 illustrates an embodiment of a global license server 410 that the global operator may operate to manage the licenses across the plural PLMNs. The license server 410 includes a license storage unit 1020 arranged to store information of the licenses for the plural PLMNs. The license server 410 also includes a license processing unit 1010. In conjunction with the license storage unit 1020, the license processing unit 1010 is arranged to practice the methods as illustrated in FIGS. 5-9.

In one aspect, it is preferred to have the license server 410 be under the control and/or supervision of the vendor providing the licenses. For example, the license server 410 can be located at the vendor's facility. This minimizes misuse of licenses. In another aspect, the license server 410 can be located at the operator's facility. This has the advantage that the communication between the PLMNs and the license server 410 is enhanced. But even in this arrangement, it is preferred that the vendor have supervision capabilities. At a minimum, the vendor having observation capabilities is preferred.

The advantage(s) of the various examples and embodiments of the described technology is as follows. For the vendor, allowing for “global” licenses should decrease the number of needed licenses. This can reduce maintenance costs and can also increase the revenue per license since the global licenses can be priced higher.

For the operator, the licenses can be purchased and used in a more flexible and efficient manner. Better trunking efficiency can be achieved by getting access to the licenses from different PLMNs. When one PLMN (or a part of the PLMN) suffers from high traffic demands, licenses can be moved from another PLMN—periodically, dynamically, or both. Also, excess hardware that have been deployed to provide a safety margin for future traffic growth or redundancy, can be used to its full extent during local or regional traffic peaks which generates more revenue. Further, priorities can be set, to ensure that the most important areas to serve get first access to the needed licenses.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly not to be limited. All structural, and functional equivalents to the elements of the above-described preferred embodiment that are known to those of ordinary skill in the art are expressly incorporated herein by reference and are intended to be encompassed hereby. Moreover, it is not necessary for a device or method to address each and every problem described herein or sought to be solved by the present technology, for it to be encompassed hereby. Furthermore, no element, component, or method act in the present disclosure is intended to be dedicated to the public. Yet further, in the method claims, the acts of the method are provided with parenthetical notations (a), (b), (c) and so on. These are provided merely for ease of reference and are not meant to convey that the acts are to be performed in any specific order.

1. A method for managing licenses for plural public land mobile networks (PLMNs) of a global operator, comprising:
(a) prioritizing a distribution of licenses among the plural PLMNs; and
(b) distributing the licenses across the plural PLMNs in response to the prioritized distribution of the licenses in the act (a).

2. The method of claim 1, wherein the acts (a) and (b) are performed by a single global license server.

3. The method of claim 1, wherein the act (a) comprises maintaining in each PLMN a predetermined minimum licensed capacity that is specified.

4. The method of claim 3,
further comprising individually configuring the predetermined minimum licensed capacity for each PLMN.

5. The method of claim 1, wherein in the act (a), the licenses are prioritized on a periodic basis.

6. The method of claim 5, wherein the act (a) comprises:
(a1) determining at least one of local time of day, day of week, and season of year for each PLMN; and
(a2) prioritizing the license distribution among the plural PLMNs based on the determination result of the act (a1).

7. The method of claim 6, wherein the act (a2) includes prioritizing PLMNs that are determined to be operating in peak hours over PLMNs that are determined to be operating in low traffic hours.

8. The method of claim 1, wherein in the act (a), the licenses are prioritized dynamically in response to mobile telephony service demands on the plural PLMNs.

9. The method of claim 8, wherein the act (a) comprises:
(a3) determining license priority of each PLMN; and
(a4) prioritizing the license distribution among the plural PLMNs based on the determination result of the act (a3).

10. The method of claim 9, wherein the act (a3) comprises prioritizing a first PLMN of the plural PLMNs to be higher than a second PLMN in response to occurrence of at least one of the following:
an amount of licensed activity of the first PLMN is greater than an amount of licensed activity the second PLMN,
a rate of increase in the licensed activity of the first PLMN is greater than a rate of increase in the licensed activity of the second PLMN,
a spare amount of licensed capacity of the first PLMN is less than a spare amount of licensed capacity the second PLMN, and
a revenue gain from the first PLMN from the license is greater than a revenue gain from the second PLMN from the license.

11. The method of claim 9, wherein in the act (a3), for each PLMN, priorities are determined for at least one of
each of one or more cluster of cells of the PLMN,
each of one or more cells of the PLMN, and
each of one or more user groups of the PLMN, and
in the act (a4), the license distribution among the plural PLMNs is also responsive to the priorities determined for at least one of
each of one or more cluster of cells of the PLMN,
each of one or more cells of the PLMN, and
each of one or more user groups of the PLMN.

12. The method of claim 1, wherein the act (b) comprises:
(b1) determining license needs for each PLMN;
(b2) determining whether there are sufficient licenses available to meet the license needs;
(b3) distributing the licenses to each PLMN when it is determined that there are sufficient licenses available in the act (b2); and
(b4) distributing the licenses so that licenses from lower priority PLMNs are moved to higher priority PLMNs when it is determined that there are not sufficient licenses available in the act (b2).

13. The method of claim 12, wherein the act (b4) comprises:
(b4A) determining whether a license distribution is hard or soft;
(b4B) waiting for a use of the license to be complete before moving the license to a higher priority PLMN when it is determined that the license distribution is soft in the act (b4A); and
(b4C) moving the license when it is determined that the license distribution is hard in the act (b4A) or after the act (b4B).

14. The method of claim 12, wherein in the act (b4), the licenses are moved to prevent a ping-pong effect in which a movement of a license from a first PLMN to a second PLMN does not cause a movement of the same license back to the first PLMN before occurrence of any one or more of:
a predetermined amount of time has passed since the movement of the license to the second PLMN,
the second PLMN has used the license for a predetermined number of times, and
a predetermined amount of revenue has been generated by the second PLMN using the license.

15. A license server arranged to manage licenses for plural networks of a global operator, the license server comprising:
a license storage unit arranged to store information of the licenses for the plural PLMNs; and
a license processing unit arranged to interface with the license storage unit and arranged to:
prioritize a distribution of licenses among the plural public land mobile networks (PLMNs), and
distribute the licenses across the plural PLMNs based on the prioritized distribution of the licenses.

16. The license server of claim 15, wherein the license storage unit is arranged to specify a predetermined minimum licensed capacity that is to be maintained for each PLMN.

17. The license server of claim 16, wherein the predetermined minimum licensed capacity is individually configurable for each PLMN.

18. The license server of claim 15, wherein the license processing unit is arranged to prioritize the licenses on a periodic basis.

19. The license server of claim 18, wherein the license processing unit is arranged to:
determine at least one of local time of day, day of week, and season of year for each PLMN, and
prioritize the license distribution among the plural PLMNs based on the determination of the at least one of local time of day, day of week, and season of year for each PLMN.

20. The license server of claim 19, wherein the license processing unit is arranged to prioritize PLMNs that are determined to be operating in peak hours over PLMNs that are determined to be operating in low traffic hours.

21. The license server of claim 15, wherein the license processing unit is arranged to dynamically prioritize the licenses based on mobile telephony service demands on the plural PLMNs.

22. The license server of claim 21, wherein the license processing unit is arranged to:
determine a license priority of each PLMN, and
prioritize the license distribution among the plural PLMNs based on the license priority of each PLMN.

23. The license server of claim 22, wherein the license processing unit is arranged to determine that a first PLMN of the plural PLMNs is to be prioritized to be higher than a second PLMN in response to occurrence of at least one of the following:
an amount of licensed activity of the first PLMN is greater than an amount of licensed activity the second PLMN,
a rate of increase in the licensed activity of the first PLMN is greater than a rate of increase in the licensed activity of the second PLMN,
a spare amount of licensed capacity of the first PLMN is less than a spare amount of licensed capacity the second PLMN, and
a revenue gain from the first PLMN from the license is greater than a revenue gain from the second PLMN from the license.

24. The license server of claim 22, wherein the license processing unit is arranged to:
for each PLMN, determine priorities for at least one of
each of one or more cluster of cells of the PLMN,
each of one or more cells of the PLMN, and
each of one or more user groups of the PLMN, and
distribute the licenses among the plural PLMNs based on the priorities determined for the at least one of
each of one or more cluster of cells of the PLMN,
each of one or more cells of the PLMN, and
each of one or more user groups of the PLMN.

25. The license server of claim 15, wherein the license processing unit is arranged to:
determine license needs for each PLMN,
determine whether there are sufficient licenses available to meet the license needs,
distribute the licenses to each PLMN when it is determined that there are sufficient licenses available, and
distribute the licenses so that licenses from lower priority PLMNs are moved to higher priority PLMNs when it is determined that there are not sufficient licenses available.

26. The license server of claim 25, wherein the license processing unit is arranged to:
determine whether a license distribution is hard or soft,
wait for a use of the license to be complete before moving the license to a higher priority PLMN when it is determined that the license distribution is soft, and
move the license when it is determined that the license distribution is hard or after waiting for the use of the license to be complete.

27. The license server of claim 26, wherein the license processing unit is arranged to prevent a ping-pong effect in which a movement of a license from a first PLMN to a second PLMN does not cause a movement of the same license back to the first PLMN before occurrence of any one or more of:
a predetermined amount of time has passed since the movement of the license to the second PLMN,
the second PLMN has used the license for a predetermined number of times, and
a predetermined amount of revenue has been generated by the second PLMN using the license.
